(19) United States
(12) Patent Application Publication
(10) Pub. No.: US 2026/0304521 A1
(43) Pub. Date: Oct. 1, 2026

(54) STEERING INFORMATION FOR A PROTOCOL DATA UNIT (PDU) SESSION REQUEST

(71) Applicant: Lenovo (United States) Inc., Morrisville, NC (US)

(72) Inventor: Roozbeh Atarius, La Jolla, CA (US)

(73) Assignee: Lenovo (United States) Inc., Morrisville, NC (US)

(21) Appl. No.: 19/094,367

(22) Filed: Mar. 28, 2025

(51) Int. Cl. H04W 76/15; H04L 47/19; H04L 69/164

(52) U.S. Cl. CPC H04W 76/15; H04L 47/196; H04L 69/164

(57) ABSTRACT

Various aspects of the present disclosure relate to steering information for a protocol data unit (PDU) session request. An apparatus, such as a network equipment (NE), receives a PDU session establishment request including first steering information, where the first steering information includes first steering capability information. The apparatus transmits second steering information, where the second steering information is based at least in part on a mapping of the first steering information via one or more mapping criteria.

### TECHNICAL FIELD

The present disclosure relates to wireless communications, and more specifically to multiple access (MA) in wireless communications.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

A UE for wireless communication is described. The UE may be configured to, capable of, or operable to perform one or more operations as described herein. For example, the UE may be configured to, capable of, or operable to transmit a first message including a protocol data unit (PDU) session establishment request including first steering information, where the first steering information includes first steering capability information of the UE; and receive, based at least in part on the first steering information, a PDU session establishment reply.

A processor (e.g., a standalone processor chipset, or a component of a UE) for wireless communication is described. The processor may be configured to, capable of, or operable to perform one or more operations as described herein. For example, the processor may be configured to, capable of, or operable to transmit a first message including a PDU session establishment request including first steering information, where the first steering information includes first steering capability information of the UE; and receive, based at least in part on the first steering information, a PDU session establishment reply.

A method performed or performable by a UE for wireless communication is described. The method may include transmitting a first message including a PDU session establishment request including first steering information, where the first steering information includes first steering capability information of the UE; and receiving, based at least in part on the first steering information, a PDU session establishment reply.

In some implementations of the UE, the processor, and the method described herein, the PDU session establishment request includes a MA PDU session establishment request.

In some implementations of the UE, the processor, and the method described herein, the PDU session establishment request is associated with device tethering to the UE.

In some implementations of the UE, the processor, and the method described herein, the first steering capability information includes one or more steering functionalities or one or more steering modes supported by the UE.

In some implementations of the UE, the processor, and the method described herein, the PDU session establishment request is transmitted via an information element.

In some implementations of the UE, the processor, and the method described herein, the first steering information is associated with one or more of a multipath quick user datagram protocol (UDP) internet protocol (IP) (MPQUIC-IP) steering functionality or an MPQUIC-IP steering mode.

An NE (e.g., a base station) for wireless communication is described. The NE may be configured to, capable of, or operable to perform one or more operations as described herein. For example, the NE may be configured to, capable of, or operable to receive a PDU session establishment request including first steering information, where the first steering information includes first steering capability information; and transmit second steering information, where the second steering information is based at least in part on a mapping of the first steering information via one or more mapping criteria.

A processor (e.g., a standalone processor chipset, or a component of a NE) for wireless communication is described. The processor may be configured to, capable of, or operable to perform one or more operations as described herein. For example, the processor may be configured to, capable of, or operable to receive a PDU session establishment request including first steering information, where the first steering information includes first steering capability information; and transmit second steering information, where the second steering information is based at least in part on a mapping of the first steering information via one or more mapping criteria.

A method performed or performable by an NE (e.g., a base station) for wireless communication is described. The method may include receiving a PDU session establishment request including first steering information, where the first steering information includes first steering capability information; and transmitting second steering information, where the second steering information is based at least in part on a mapping of the first steering information via one or more mapping criteria.

In some implementations of the NE, the processor, and the method described herein, the PDU session establishment request includes a MA PDU session establishment request.

In some implementations of the NE, the processor, and the method described herein, the PDU session establishment request is received from a UE.

In some implementations of the NE, the processor, and the method described herein, the PDU session establishment request is associated with device tethering to the UE.

In some implementations of the NE, the processor, and the method described herein, the first steering capability information includes one or more steering functionalities or one or more steering modes supported by the UE.

In some implementations of the NE, the processor, and the method described herein, when a value associated with the first steering capability information cannot be interpreted by the first NE, and the NE, the processor, and the method may further be configured to, capable of, operable to, performed to, or performable to reject the PDU establishment request; and transmit an error cause based at least in part on rejection of the PDU establishment request.

In some implementations of the NE, the processor, and the method described herein, the transmitted error cause is based at least in part on an error cause indicated in 3GPP technical specification (TS) section 24.501.

In some implementations of the NE, the processor, and the method described herein, the second steering information is transmitted to a second NE, and the NE, the processor, and the method may further be configured to, capable of, operable to, performed to, or performable to receive, from the second NE, one or more rules for PDU session establishment; and transmit at least a portion of the one or more rules.

In some implementations of the NE, the processor, and the method described herein, the first NE includes a session management function (SMF), and the second NE includes a policy control function (PCF).

In some implementations of the NE, the processor, and the method described herein, the one or more rules include access traffic steering, switching, splitting (ATSSS) rules.

In some implementations of the NE, the processor, and the method described herein, the PDU session establishment request is received via an information element.

In some implementations of the NE, the processor, and the method described herein, the first steering information includes a first set of steering information and a second set of steering information, and where the second steering information is based at least in part on the first set of steering information and the second set of steering information.

In some implementations of the NE, the processor, and the method described herein, the NE, the processor, and the method may further be configured to, capable of, operable to, performed to, or performable to transmit an indication to provide a session management (SM) context identifier for a PDU session.

In some implementations of the NE, the processor, and the method described herein, one or more of the first steering information or the second steering information is associated with one or more of an MPQUIC-IP steering functionality or an MPQUIC-IP steering mode.

### BRIEF DESCRIPTION OF THE DRAWINGS

FIG. 1 illustrates an example of a wireless communications system in accordance with aspects of the present disclosure.

FIG. 2 illustrates an example system in accordance with aspects of the present disclosure.

FIG. 3 illustrates an example system in accordance with aspects of the present disclosure.

FIG. 4 illustrates an example of a UE in accordance with aspects of the present disclosure.

FIG. 5 illustrates an example of a processor in accordance with aspects of the present disclosure.

FIG. 6 illustrates an example of an NE in accordance with aspects of the present disclosure.

FIG. 7 illustrates a flowchart of a method in accordance with aspects of the present disclosure.

FIG. 8 illustrates a flowchart of a method in accordance with aspects of the present disclosure.

### DETAILED DESCRIPTION

In a wireless communications system, a UE and an NE (e.g., a base station, gNB) may support wireless communication (e.g., reception and/or transmission of wireless communication) using time-frequency resources. MA techniques may be employed to enable time-frequency resources to be used for data communication for devices that do not support some wireless communication protocols, e.g., non-3GPP devices. A non-3GPP device may represent a device that lacks functionality to directly connect to a 3GPP wireless communication network. In such scenarios, a non-3GPP device may connect to a 3GPP compliant device to obtain data connectivity to a 3GPP network, which may be referred to as device tethering. In device tethering implementations, a 3GPP device (e.g., a UE) may establish an IP tunnel between a 3GPP network and a non-3GPP device to enable data to be communicated (transmitted, received) between the 3GPP network and the non-3GPP device.

In MA implementations, traffic steering (also referred to herein as “steering”) can be performed to manage data traffic across different device and network resources. For example, steering can be used to route data flows between different types of data networks, such as between 3GPP data networks (e.g., wireless cellular networks) and non-3GPP data networks, e.g., WiFi networks. Steering can be used to adapt to various conditions, such as to route and reroute data traffic based on conditions such as network delay, network load, data priority, etc. In some wireless communications systems, access traffic steering, switching, and splitting (ATSSS) protocols can be utilized to perform steering operations. ATSSS can provide rules and parameters for controlling steering, such as based on dynamic network and data flow conditions. MPQUIC protocols can also be used for steering using different connectivity types, including 3GPP data connectivity and non-3GPP data connectivity. Some wireless communications networks, however, may encounter challenges in implementing steering functionality when wireless standards (e.g., 3GPP standards) evolve, which may result in compatibility issues between devices that are compliant with different versions of wireless standards.

Aspects of the present disclosure are described in the context of a wireless communications system, and include implementations that provide for steering compatibility in wireless communications systems. In some examples, an NE (e.g., an SMF) can receive, from a UE, a PDU establishment request including first steering information that indicates steering capability information of the UE. The NE can utilize the steering capability information to determine whether and/or how to establish a PDU session between the UE and a network. For example, for different implementations of an NE, a PDU session may or may not be established based on supported steering functionalities. In some examples, a PDU session can be established for a tethering implementation, such as to tether a non-3GPP device to a 3GPP device (e.g., UE) for providing a data connection between the non-3GPP device and a 3GPP network.

By performing the described techniques, a wireless device and a wireless communications system can perform MA techniques that are adaptable to different instances of UEs and NEs, such as to adapt steering capabilities as part of MA UDP sessions.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

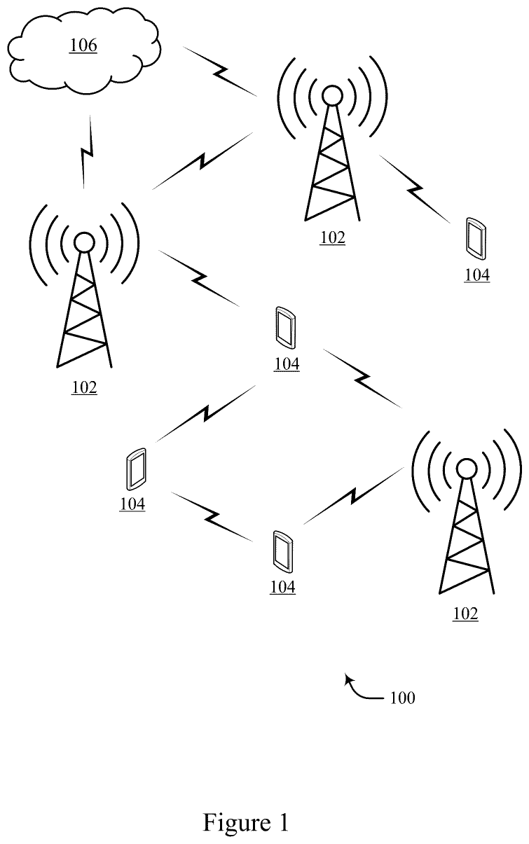

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a PDU session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a UE 104 may transmit, to a NE 102 (e.g., an SMF), a first message including a PDU session establishment request including first steering information, where the first steering information includes first steering capability information of the UE. The UE 104 may receive, based at least in part on the first steering information, a PDU session establishment reply.

In implementations, a NE 102 may receive, from a UE 104, a PDU session establishment request including first steering information, where the first steering information includes first steering capability information. The NE 102 may transmit second steering information, where the second steering information is based at least in part on a mapping of the first steering information via one or more mapping criteria.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

With reference to MA in wireless communications systems, 3GPP TS 23.501 describes multipath transmission control protocol (MPTCP), MPQUIC, and ATSSS-lower layer (LL) steering functionalities, where the MPQUIC steering functionality can be applied to IP, UDP, and Ethernet, e.g., MPQUIC-IP, MPQUIC-UDP, and MPQUIC-E. (See 3GPP TS 23.501, version 19.2.1, 7 Jan. 2025, titled “System architecture for the 5G System (5GS),” hereinafter referred to as “TS 23.501”, which is hereby incorporated by reference herein in its entirety). While a UPF can support “ATSSS-LL functionality with Active Standby steering mode” according to TS 23.501, a UE may select a steering functionality for a MA PDU session establishment. The steering functionality, for example can be selected from the following:
1) ATSSS-LL functionality with any steering mode
2) MPTCP functionality with any steering mode and ATSSS-LL functionality with only Active-Standby steering mode
3) MPQUIC-UDP functionality with any steering mode and ATSSS-LL functionality with only Active-Standby steering mode
4) MPQUIC IP functionality with any steering mode without any ATSSS-LL functionality
5) MPQUIC IP functionality with any steering mode and ATSSS-LL functionality with only Active-Standby steering mode
6) MPQUIC-E functionality with any steering mode and ATSSS-LL functionality with only Active-Standby steering mode

In other versions of the TS, the steering functionality can be selected from the following:
1) ATSSS-LL functionality with any steering mode
2) MPTCP functionality with any steering mode and ATSSS-LL functionality with any steering mode
3) MPTCP functionality with any steering mode and ATSSS-LL functionality with only Active-Standby steering mode.

One challenge that arises is how a UE can request steering functionality and steering mode for (e.g., at the time of) MA PDU session establishment when the UE and the network (e.g., SMF) are from different versions (e.g., releases) of the 3GPP TS.

In some wireless communications systems, MA PDU establishment involves multiple states. According to stage 2 parameters in TS 23.501, the UPF shall at a minimum support “ATSSS-LL functionality with Active Standby steering mode”, while the UE may choose steering functionalities and steering modes as listed above. Considering TS 24.501 in rel-19, Table 9.11.4.1.1 indicates that “The UE shall populate these bits in the same way as a UE of a previous release,” where “these bits” refers to ATSSS-ST that is to be populated in the same manner in other releases, e.g., as in rel-17. (See 3GPP TS 24.501, Version 19.1.1, 16 Jan. 2025, titled “Non-Access-Stratum (NAS) protocol for 5G System (5GS); Stage 3,” hereinafter referred to as “TS 24.501”, which is hereby incorporated by reference herein in its entirety).

Furthermore, NOTE 7A in clause 6.4.2.2 and NOTE 4A in clause 6.4.1.2 of TS 24.501 rel-19 indicate that: “Usage of the ATSSS-ST bits to indicate support for ATSSS functionality was deprecated in Rel-18 in favor of the ATSSS-LL, MPTCP, MPQUIC-UDP, MPQUIC-IP and MPQUIC-E bits. The setting of the ATSSS-ST bits is necessary for backward compatibility with the earlier releases. The UE sets the ATSSS-ST field in the same way as a UE from previous releases.”

In some developments in wireless communications systems, and in contrast to stage 2 parameters mentioned above, a new parameter indicates that the UE is to support “ATSSS-LL functionality with Active Standby steering mode.” An issue is thus why stage 2 does not indicate that the UE is to support at the minimum “ATSSS-LL functionality with Active Standby steering mode,” which may be explained in the following use case where the UE is used to pass the IP packets to the internet by other devices that do not have capability to connect to a wireless cellular network, e.g., a 3GPP network. Such use cases may be referred to as tethering from a non-3GPP device to a 3GPP device. In such scenarios, stage 2 may involve that the UE uses “MPQUIC IP functionality with any steering mode without any ATSSS-LL functionality” at the time of MA PDU session establishment. FIG. 1 shows the configuration for the UE which is used for tethering.

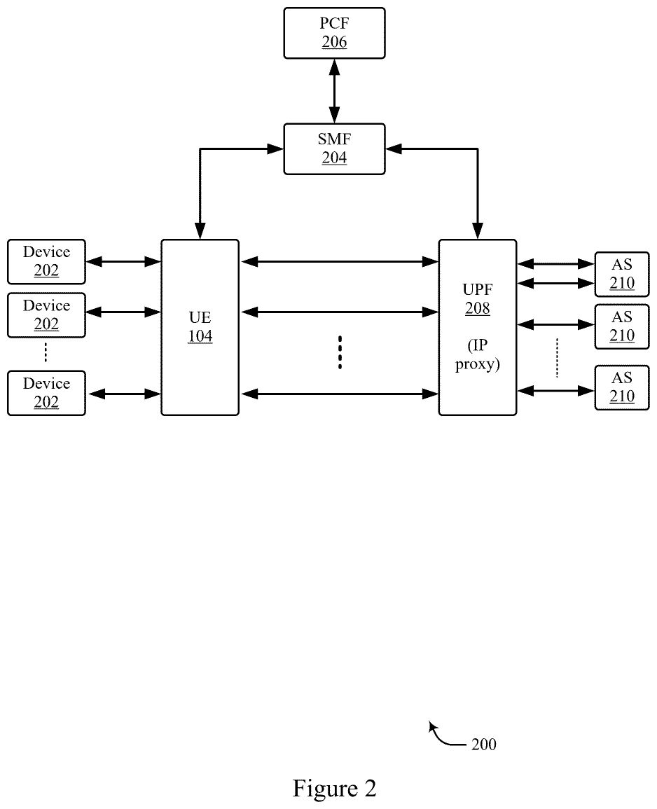

FIG. 2 illustrates an example system 200 in accordance with aspects of the present disclosure. The system 200 can be implemented to enable devices 202 to transmit and receive data packets via a wireless cellular network, e.g., 3GPP network. In the system 200, the devices 202 are connected to a UE 104, such as via a wireless and/or wired connection. The devices 202 may represent devices that do not have capability to directly connect with a wireless cellular network. Examples of the devices 202 include tablet computers, laptop computers, desktop computers, internet of things (IoT) devices, etc. The UE 104 may communicate with an SMF 204 to request PDU session establishment, and the SMF 204 may communicate with a PCF 206 to obtain policy information for the PDU session. Based on the obtained policy information, the UE 104 may establish UDP flows with a UPF 208, which can enable IP packets to be communicated via the UE 104 between the devices 202 and application servers (AS) 210.

In the system 200, the UE 104 may only be capable of MPQUIC steering functionality for IP packets which are transmitted to between the devices 202 and the UPF 208, e.g., the network. Since TS 23.501 indicates that the ATSSS UE is to be capable of only a steering functionality, the UE may not be required to implement ATSSS-LL with the steering modes defined in TS 23.501. In some wireless communications systems, for a UE which may be implemented for connecting devices (e.g., devices 202) to an IP network (e.g., internet), the UE may be instructed to understand and implement “ATSSS-LL functionality with Active Standby steering mode,” which may be of no utility in such tethering-only scenarios.

Aspects of the present disclosure include solutions to steering information for a PDU session request. In some first example implementations, for a rel-19 UE which is to implement IP tethering (e.g., a use case shown in the system 200), the rel-19 UE as part of MA PDU session establishment may set:
1) ATSSS-ST bits in Table 9.11.4.1.1 in 3GPP TS 24.501 [2] to the value corresponding to ATSSS-LL steering functionality, i.e., “0001”, indicating “ATSSS Low-Layer functionality with any steering mode allowed for ATSSS-LL supported”;
2) MPQUIC-IP bit in Table 9.11.4.1.1 in 3GPP TS 24.501 [2] to “1”; and
3) ATSSS-LL bits in Table 9.11.4.1.1 in 3GPP TS 24.501 [2] to “01”, indicating “ATSSS-LL functionality with any steering mode allowed for ATSSS-LL supported ” which can be the same as ATSSS-ST bits being set to “0001”.

In such first example implementations, a rel-19 SMF may ignore the ATSSS-ST bits and determine that the bits for MPQUIC-IP bit and ATSSS-LL bits are for “MPQUIC IP functionality with any steering mode and ATSSS-LL functionality with any allowed ATSSS-LL steering mode” which is different than “MPQUIC IP functionality with any steering mode and ATSSS-LL functionality with only Active-Standby steering mode”. Such an event can represent a trigger that causes the SMF to ignore the ATSSS-LL functionality and request the PCF for the PCC rules for “MPQUIC IP functionality with any steering mode”.

In such first example implementations, a rel-18 SMF may ignore the ATSSS-ST rules bits and only understand the ATSSS-LL bits indicating “ATSSS-LL functionality with any steering mode allowed for ATSSS-LL supported”. The rel-18 SMF may request the PCF for PCC-rules. Based on receipt of the ATSSS rules, the UE may determine that the ATSSS-rules are for “ATSSS-LL functionality with any steering mode allowed for ATSSS-LL supported ” and release the MA PDU session.

In such first example implementations, a rel-17 SMF may only understand the ATSSS-ST bits (e.g., “ATSSS Low-Layer functionality with any steering mode allowed for ATSSS-LL supported,” and request PCC rules accordingly. Based on receipt of the ATSSS rules, the UE may determine that the ATSSS rules are for “ATSSS Low-Layer functionality with any steering mode allowed for ATSSS-LL supported ” and release the MA PDU session.

In some second example implementations, for a rel-19 UE which is to implement IP tethering (e.g., a use case shown in the system 200), the rel-19 UE as part of MA PDU session establishment may set:
1) ATSSS-ST bits in Table 9.11.4.1.1 in 3GPP TS 24.501 to the value corresponding to ATSSS-LL steering functionality (i.e., “0001”), indicating “ATSSS Low-Layer functionality with any steering mode allowed for ATSSS-LL supported”;
2) MPQUIC-IP bit in Table 9.11.4.1.1 in 3GPP TS 24.501 to “1”; and
3) ATSSS-LL bits in Table 9.11.4.1.1 in 3GPP TS 24.501 to “00”, indicating “ATSSS-LL functionality not supported”.

In such second example implementations, a rel-19 SMF may determine that the MPQUIC-IP bit indicates “MPQUIC IP functionality with any steering mode is supported ” and ATSSS-LL bits indicate “ATSSS-LL functionality not supported”, while ATSSS-ST bits indicate “ATSSS Low-Layer functionality with any steering mode allowed for ATSSS-LL supported”. Such an event can represent a trigger that causes the SMF to ignore the ATSSS-ST functionality and request the PCF for the PCC rules for only “MPQUIC IP functionality with any steering mode is supported”.

In such second example implementations, a rel-18 SMF may determine that the ATSSS-LL bits are indicating “ATSSS-LL functionality not supported”. However, ATSSS-ST bits may indicate “ATSSS Low-Layer functionality with any steering mode allowed for ATSSS-LL supported”. The rel-18 SMF may determine that the UE is a legacy UE, and the rel-18 SMF may requests the PCF for PCC-rules according to the ATSSS-ST bits indicating “ATSSS Low-Layer functionality with any steering mode allowed for ATSSS-LL supported”. Based on receipt of the ATSSS rules, the UE may determine that the ATSSS-rules are for “ATSSS-LL functionality with any steering mode allowed for ATSSS-LL supported ” and may release the MA PDU session.

In such second example implementations, a rel-17 SMF may only be able to interpret the ATSSS-ST bits (i.e., “ATSSS Low-Layer functionality with any steering mode allowed for ATSSS-LL supported,” and the rel-17 SMF may request the PCC rules accordingly. Based on receipt of the ATSSS rules, the UE may determine that the ATSSS rules are for “ATSSS Low-Layer functionality with any steering mode allowed for ATSSS-LL supported ” and may release the MA PDU session.

In some third example implementations, for a rel-19 UE which is to implement IP tethering (e.g., a use case shown in the system 200), the rel-19 UE as part of MA PDU session establishment may set:
1) ATSSS-ST bits in Table 9.11.4.1.1 in 3GPP TS 24.501 to the value corresponding to ATSSS-LL steering functionality (i.e., “0000”), indicating “ATSSS-LL functionality not supported”;
2) MPQUIC-IP bit in Table 9.11.4.1.1 in 3GPP TS 24.501 to “1”; and
3) ATSSS-LL bits in Table 9.11.4.1.1 in 3GPP TS 24.501 to “00”, indicating “ATSSS-LL functionality not supported”.

In such third example implementations, a rel-19 SMF may ignore the ATSSS-ST bits and determine that the MPQUIC-IP bit is for “MPQUIC IP functionality with any steering mode is supported ” and request from the PCF the PCC rules for only “MPQUIC IP functionality with any steering mode is supported”.

In such third example implementations, a rel-18 SMF may not be able to interpret the MPQUIC-IP bit and can determine that the ATSSS-ST bits indicate “ATSSS-LL functionality not supported ” and that the ATSSS-LL bits indicate “ATSSS-LL functionality not supported”. Such an event can represent a trigger that causes the rel-18 SMF to release the MA PDU session based on the PDU session establishment request being for an MA PDU session, with the rel-18 SMF determining that the UE does not indicate steering functionality and steering mode support for the MA PDU session. The rel-18 SMF may use a cause value indicating that the requested steering functionality and steering mode is not supported by the network based on the release the MA PDU session.

In such third example implementations, a rel-17 SMF may determine that the ATSSS-ST bits represent “ATSSS-LL functionality not supported”. Such an event can represent a trigger that causes the rel-17 SMF to release the MA PDU session based on a determination that the PDU session establishment request is for an MA PDU session and based on the rel-17 SMF determining that the UE does not indicate steering functionality and steering mode support for the MA PDU session. The rel-17 SMF may use a cause value indicating that the requested steering functionality and steering mode is not supported by the network based on the release the MA PDU session.

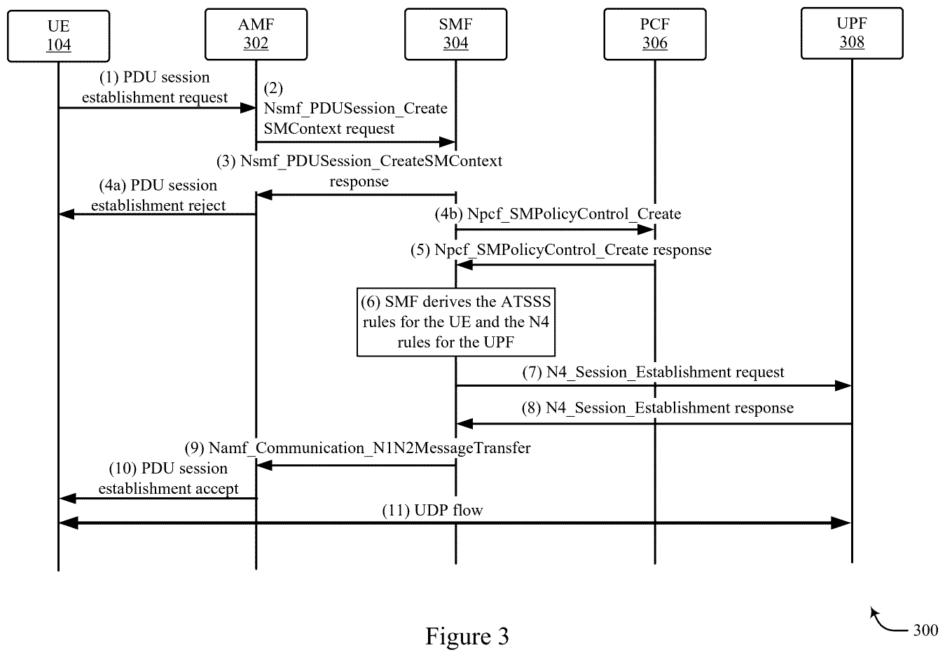

FIG. 3 illustrates an example system 300 in accordance with aspects of the present disclosure. The system 300 illustrates an example UE-requested MA PDU session establishment based on a UE 104 being registered to the network. In the system 300: At step (1), the UE 104 initiates a UE-requested PDU session establishment procedure by communicating information elements (IEs) to an AMF 302. The IEs include a 5GSM capability IE including one or more configurations, such as described herein with reference to the first, second, and third implementations. The IEs may be included within an NAS message for PDU session establishment.

At step (2), based on determining an SMF 304, the AMF 302 can generate an Nsmf_PDUSession_CreateSMContext request with information elements to generate an SM context. At step (3), based on creating the SM context (e.g., as described with reference to the first, second, and third implementations described above), the SMF 304 may perform different operations. In a first operation, the SMF 304 may reject the AMF 302 via a Nsmf_PDUSession_CreateSMContext response (PDU Session Reject (Cause)), where the rejection may be for the case described in the third implementations described above. In the first operation, a wireless communication network which cannot interpret the indication for the MPQUIC-IP, determines that the UE request for the MA PDU session establishment while the ATSSS-ST bits have the value “ATSSS not supported”. The request may be processed as an abnormal case and rejected by a 5GSM cause such as “Unknown PDU session type”. In a second operation, the SMF 304 may communicate an Nsmf_PDUSession_CreateSMContext response to the AMF 302 to provide the SM context ID. At step (4a), if the PDU session request is rejected, the AMF 302 may communicate to the UE 104 a rejection of the MA PDU session establishment with a PDU session establishment reject (PDU Session Reject (Cause)).

In the system 300, if the SMF 304 does not reject the MA PDU session establishment: At step (4b), the SMF communicates a request to a PCF 306 to establish an SM policy association by transmitting information for PDU session via Npcf_SMPolicyControl_Create. The SMF 304 may notify the PCF 306 of supported steering functionalities and steering modes of the UE 104 based on interpretation by the SMF 304 of supported steering functionalities and steering modes of the UE 104, such as described with reference to the first, second, and third implementations described above. In the following steps, the SMF 304 may correctly determine the UE requested supported MPQUIC-IP steering functionality and steering mode.

At step (5), the PCF 306 may communicate to the SMF 304 the SMF policy information as PCC rules via Npcf_SMPolicyControl_Create response. The PCC rules may include MPQUIC steering functionality, transport mode, and connect-ip protocol, and optionally the “ipproto” and “target” parameters associated with connect-ip. At step (6), based on the received PCC rules, the SMF 304 may derive (a) ATSSS rules, which may be sent to the UE 104 for controlling the traffic steering, switching, and splitting in the uplink direction, and (b) N4 rules, which may be sent to a UPF 308 for controlling the traffic steering, switching, and splitting in the downlink direction.

At step (7), the SMF 304 may initiate the N4 Session establishment procedure with the UPF 308 by sending N4 rules derived by the SMF 304 for the MA PDU session to instruct the UPF 308 to activate the MPQUIC functionality for IP packets and MPQUIC-IP for the MA PDU session. At step (8), the UPF 308 may allocate the UE “MPQUIC link-specific multipath” addresses/prefixes and send the “MPQUIC link-specific multipath” addresses/prefixes and MPQUIC proxy information to the SMF 304.

At step (9), the SMF 304 may include an “MA PDU session Accepted” indication in the Namf_Communication_N1N2MessageTransfer message to the AMF 203, and indicate to the AMF 302 that the N2 SM Information included in the message is to be sent to the UE 104. The AMF 302 may mark the PDU session as a MA PDU session based on the received “MA PDU session Accepted” indication. At step (10), the UE 104 receives a PDU session establishment accept message, which indicates to UE 104 that the requested MA PDU session was successfully established. This message may include the ATSSS rules for the MA PDU session, which were derived by the SMF 304, and the “MPQUIC link-specific multipath” addresses/prefixes of the UE 104 and the MPQUIC proxy information for IP packets. In some examples, the SMF 304 correctly interprets the UE requested supported MPQUIC-IP steering functionality and steering mode, and the UE 104 establishes an IP tunnel towards the UPF 308 to comply with the configuration of a use case such as described with reference to the system 200.

At step (11), uplink and downlink data flows of a UDP flow may be established for a MA PDU session. The UE 104 may use the ATSSS rules to establish the UDP flow. Based on the SMF 304 correctly interpreting the UE requested supported MPQUIC-IP steering functionality and steering mode, the UE 104 may, according to the received ATSSS rules, establish the IP tunnel towards the UPF 308 to comply with the configuration of a use case such as described with reference to the system 200. If the SMF 304 cannot correctly interpret the UE requested supported steering functionalities and steering modes and receives ATSSS rules diverging from the use case such as described with reference to the system 200, the UE 104 may release the MA PDU session.

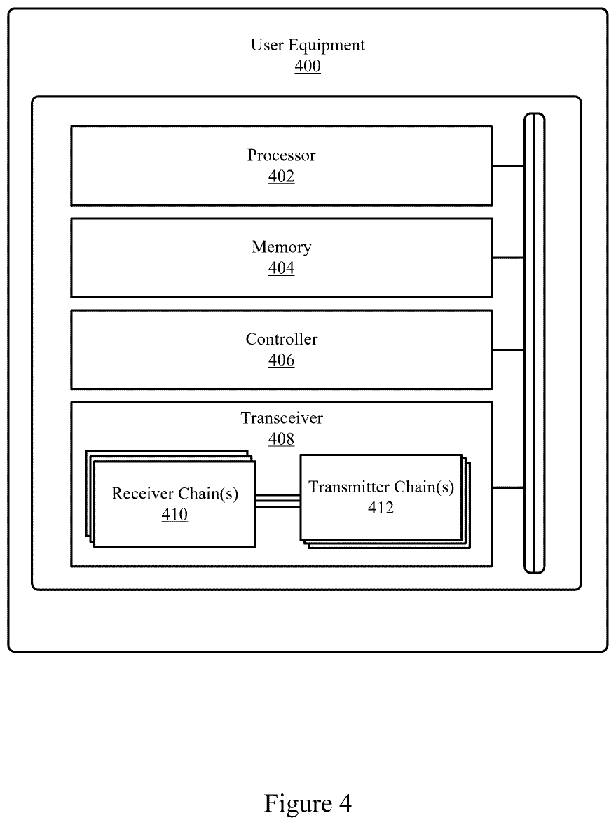

FIG. 4 illustrates an example of a UE 400 in accordance with aspects of the present disclosure. The UE 400 may include a processor 402, a memory 404, a controller 406, and a transceiver 408. The processor 402, the memory 404, the controller 406, or the transceiver 408, or various combinations thereof or various components thereof may be examples of means for performing various aspects of the present disclosure as described herein. These components may be coupled (e.g., operatively, communicatively, functionally, electronically, electrically) via one or more interfaces.

The processor 402, the memory 404, the controller 406, or the transceiver 408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 402 may include an intelligent hardware device (e.g., a general-purpose processor, a DSP, a CPU, an ASIC, an FPGA, or any combination thereof). In some implementations, the processor 402 may be configured to operate the memory 404. In some other implementations, the memory 404 may be integrated into the processor 402. The processor 402 may be configured to execute computer-readable instructions stored in the memory 404 to cause the UE 400 to perform various functions of the present disclosure.

The memory 404 may include volatile or non-volatile memory. The memory 404 may store computer-readable, computer-executable code including instructions when executed by the processor 402 cause the UE 400 to perform various functions described herein. The code may be stored in a non-transitory computer-readable medium such as the memory 404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the UE 400 may support at least one memory (e.g., the memory 404) and at least one processor (e.g., the processor 402) coupled with the at least one memory and configured to cause the UE to transmit a first message including a PDU session establishment request including first steering information, where the first steering information includes first steering capability information of the UE; and receive, based at least in part on the first steering information, a PDU session establishment reply.

Additionally, the UE 400 may be configured to support any one or combination of where the PDU session establishment request includes a MA PDU session establishment request; the PDU session establishment request is associated with device tethering to the UE; the first steering capability information includes one or more steering functionalities or one or more steering modes supported by the UE; the PDU session establishment request is transmitted via an information element; the first steering information is associated with one or more of an MPQUIC-IP steering functionality or an MPQUIC-IP steering mode.

The controller 406 may manage input and output signals for the UE 400. The controller 406 may also manage peripherals not integrated into the UE 400. In some implementations, the controller 406 may utilize an operating system such as iOS®, ANDROID®, WINDOWS®, or other operating systems. In some implementations, the controller 406 may be implemented as part of the processor 402.

In some implementations, the UE 400 may include at least one transceiver 408. In some other implementations, the UE 400 may have more than one transceiver 408. The transceiver 408 may represent a wireless transceiver. The transceiver 408 may include one or more receiver chains 410, one or more transmitter chains 412, or a combination thereof.

A receiver chain 410 may be configured to receive signals (e.g., control information, data, packets) over a wireless medium. For example, the receiver chain 410 may include one or more antennas to receive a signal over the air or wireless medium. The receiver chain 410 may include at least one amplifier (e.g., a low-noise amplifier (LNA)) configured to amplify the received signal. The receiver chain 410 may include at least one demodulator configured to demodulate the receive signal and obtain the transmitted data by reversing the modulation technique applied during transmission of the signal. The receiver chain 410 may include at least one decoder for decoding the demodulated signal to receive the transmitted data.

A transmitter chain 412 may be configured to generate and transmit signals (e.g., control information, data, packets). The transmitter chain 412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 412 may also include at least one power amplifier configured to amplify the modulated signal to an appropriate power level suitable for transmission over the wireless medium. The transmitter chain 412 may also include one or more antennas for transmitting the amplified signal into the air or wireless medium.

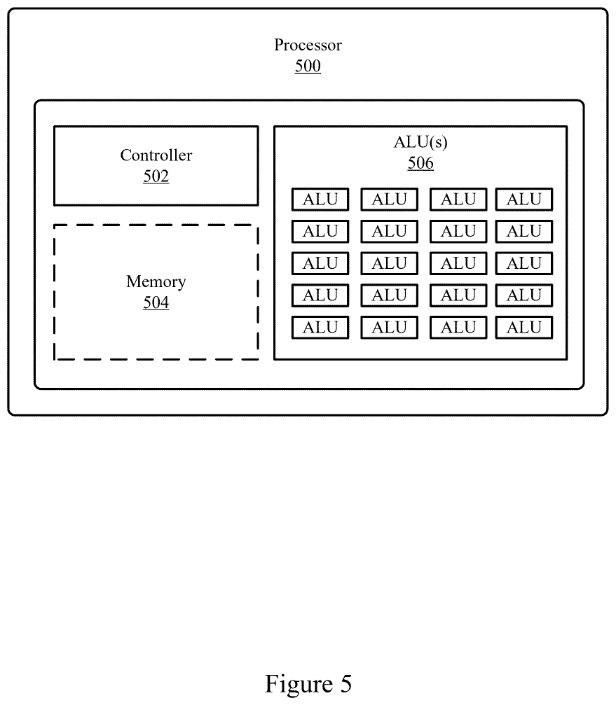

FIG. 5 illustrates an example of a processor 500 in accordance with aspects of the present disclosure. The processor 500 may be an example of a processor configured to perform various operations in accordance with examples as described herein. The processor 500 may include a controller 502 configured to perform various operations in accordance with examples as described herein. The processor 500 may optionally include at least one memory 504, which may be, for example, an L1/L2/L3 cache. Additionally, or alternatively, the processor 500 may optionally include one or more arithmetic-logic units (ALUs) 506. One or more of these components may be in electronic communication or otherwise coupled (e.g., operatively, communicatively, functionally, electronically, electrically) via one or more interfaces (e.g., buses).

The processor 500 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 500) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 502 may be configured to manage and coordinate various operations (e.g., signaling, receiving, obtaining, retrieving, transmitting, outputting, forwarding, storing, determining, identifying, accessing, writing, reading) of the processor 500 to cause the processor 500 to support various operations in accordance with examples as described herein. For example, the controller 502 may operate as a control unit of the processor 500, generating control signals that manage the operation of various components of the processor 500. These control signals include enabling or disabling functional units, selecting data paths, initiating memory access, and coordinating timing of operations.

The controller 502 may be configured to fetch (e.g., obtain, retrieve, receive) instructions from the memory 504 and determine subsequent instruction(s) to be executed to cause the processor 500 to support various operations in accordance with examples as described herein. The controller 502 may be configured to track memory addresses of instructions associated with the memory 504. The controller 502 may be configured to decode instructions to determine the operation to be performed and the operands involved. For example, the controller 502 may be configured to interpret the instruction and determine control signals to be output to other components of the processor 500 to cause the processor 500 to support various operations in accordance with examples as described herein. Additionally, or alternatively, the controller 502 may be configured to manage flow of data within the processor 500. The controller 502 may be configured to control transfer of data between registers, ALUs 506, and other functional units of the processor 500.

The memory 504 may include one or more caches (e.g., memory local to or included in the processor 500 or other memory, such as RAM, ROM, DRAM, SDRAM, SRAM, MRAM, flash memory, etc. In some implementations, the memory 504 may reside within or on a processor chipset (e.g., local to the processor 500). In some other implementations, the memory 504 may reside external to the processor chipset (e.g., remote to the processor 500).

The memory 504 may store computer-readable, computer-executable code including instructions that, when executed by the processor 500, cause the processor 500 to perform various functions described herein. The code may be stored in a non-transitory computer-readable medium such as system memory or another type of memory. The controller 502 and/or the processor 500 may be configured to execute computer-readable instructions stored in the memory 504 to cause the processor 500 to perform various functions. For example, the processor 500 and/or the controller 502 may be coupled with or to the memory 504, the processor 500, and the controller 502, and may be configured to perform various functions described herein. In some examples, the processor 500 may include multiple processors and the memory 504 may include multiple memories. One or more of the multiple processors may be coupled with one or more of the multiple memories, which may, individually or collectively, be configured to perform various functions herein.

The one or more ALUs 506 may be configured to support various operations in accordance with examples as described herein. In some implementations, the one or more ALUs 506 may reside within or on a processor chipset (e.g., the processor 500). In some other implementations, the one or more ALUs 506 may reside external to the processor chipset (e.g., the processor 500). One or more ALUs 506 may perform one or more computations such as addition, subtraction, multiplication, and division on data. For example, one or more ALUs 506 may receive input operands and an operation code, which determines an operation to be executed. One or more ALUs 506 may be configured with a variety of logical and arithmetic circuits, including adders, subtractors, shifters, and logic gates, to process and manipulate the data according to the operation. Additionally, or alternatively, the one or more ALUs 506 may support logical operations such as AND, OR, exclusive-OR (XOR), not-OR (NOR), and not-AND (NAND), enabling the one or more ALUs 506 to handle conditional operations, comparisons, and bitwise operations.

The processor 500 may support wireless communication in accordance with examples as disclosed herein. The processor 500 may be configured to or operable to support at least one controller (e.g., the controller 502) coupled with at least one memory (e.g., the memory 504) and configured to cause the processor to receive a PDU session establishment request including first steering information, where the first steering information includes first steering capability information; and transmit second steering information, where the second steering information is based at least in part on a mapping of the first steering information via one or more mapping criteria.

Additionally, the processor 500 may be configured to or operable to support any one or combination of where the PDU session establishment request includes a MA PDU session establishment request; the PDU session establishment request is received from a UE; the PDU session establishment request is associated with device tethering to the UE; the first steering capability information includes one or more steering functionalities or one or more steering modes supported by the UE; when a value associated with the first steering capability information cannot be interpreted by the first NE, the at least one processor is operable to cause the first NE to: reject the PDU establishment request; and transmit an error cause based at least in part on rejection of the PDU establishment request; the transmitted error cause is based at least in part on an error cause indicated in 3GPP TS section 24.501; the second steering information is transmitted to a second NE, and where the at least one processor is operable to cause the first NE to: receive, from the second NE, one or more rules for PDU session establishment; and transmit at least a portion of the one or more rules; the first NE includes a SMF, and the second NE includes a PCF; the one or more rules include ATSSS rules; the PDU session establishment request is received via an information element; the first steering information includes a first set of steering information and a second set of steering information, and where the second steering information is based at least in part on the first set of steering information and the second set of steering information; the at least one processor is operable to cause the NE to: transmit an indication to provide a SM context identifier for a PDU session; one or more of the first steering information or the second steering information is associated with one or more of an MPQUIC-IP steering functionality or an MPQUIC-IP steering mode.

The processor 500 may support wireless communication in accordance with examples as disclosed herein. The processor 500 may be configured to or operable to support at least one controller (e.g., the controller 502) coupled with at least one memory (e.g., the memory 504) and configured to cause the processor to transmit a first message including a PDU session establishment request including first steering information, where the first steering information includes first steering capability information of the UE; and receive, based at least in part on the first steering information, a PDU session establishment reply.

Additionally, the processor 500 may be configured to or operable to support any one or combination of where the PDU session establishment request includes a MA PDU session establishment request; the PDU session establishment request is associated with device tethering to the UE; the first steering capability information includes one or more steering functionalities or one or more steering modes supported by the UE; the PDU session establishment request is transmitted via an information element; the first steering information is associated with one or more of an MPQUIC-IP steering functionality or an MPQUIC-IP steering mode.

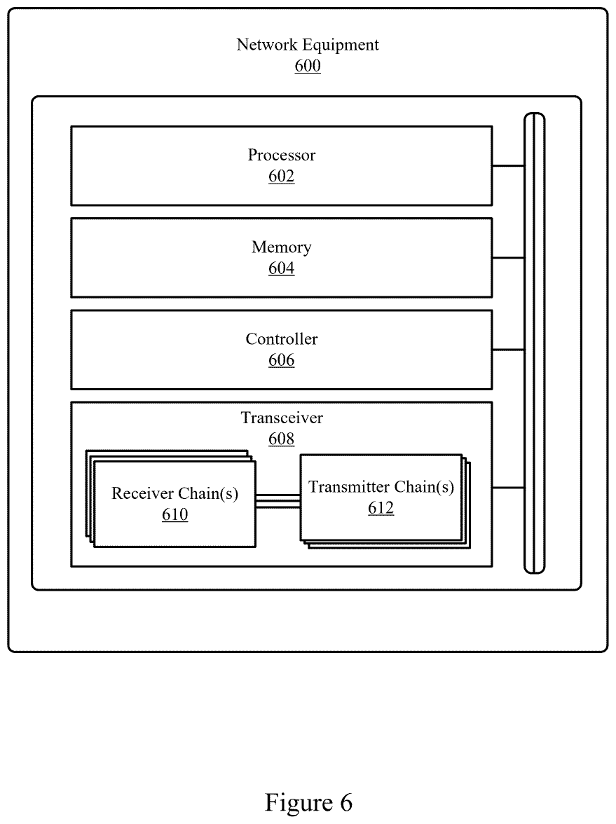

FIG. 6 illustrates an example of an NE 600 in accordance with aspects of the present disclosure. The NE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the NE 600 to perform various functions of the present disclosure.

The memory 604 may include volatile or non-volatile memory. The memory 604 may store computer-readable, computer-executable code including instructions when executed by the processor 602 cause the NE 600 to perform various functions described herein. The code may be stored in a non-transitory computer-readable medium such as the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the NE 600 may support at least one memory (e.g., the memory 604) and at least one processor (e.g., the processor 602) coupled with the at least one memory and configured to cause the NE to receive a PDU session establishment request including first steering information, where the first steering information includes first steering capability information; and transmit second steering information, where the second steering information is based at least in part on a mapping of the first steering information via one or more mapping criteria.

Additionally, the NE 600 may be configured to support any one or combination of where the PDU session establishment request includes a MA PDU session establishment request; the PDU session establishment request is received from a UE; the PDU session establishment request is associated with device tethering to the UE; the first steering capability information includes one or more steering functionalities or one or more steering modes supported by the UE; when a value associated with the first steering capability information cannot be interpreted by the first NE, the at least one processor is operable to cause the first NE to: reject the PDU establishment request; and transmit an error cause based at least in part on rejection of the PDU establishment request; the transmitted error cause is based at least in part on an error cause indicated in 3GPP TS section 24.501; the second steering information is transmitted to a second NE, and where the at least one processor is operable to cause the first NE to: receive, from the second NE, one or more rules for PDU session establishment; and transmit at least a portion of the one or more rules; the first NE includes a SMF, and the second NE includes a PCF; the one or more rules include ATSSS rules; the PDU session establishment request is received via an information element; the first steering information includes a first set of steering information and a second set of steering information, and where the second steering information is based at least in part on the first set of steering information and the second set of steering information; the at least one processor is operable to cause the NE to: transmit an indication to provide a SM context identifier for a PDU session; one or more of the first steering information or the second steering information is associated with one or more of an MPQUIC-IP steering functionality or an MPQUIC-IP steering mode.

The controller 606 may manage input and output signals for the NE 600. The controller 606 may also manage peripherals not integrated into the NE 600. In some implementations, the controller 606 may utilize an operating system such as iOS®, ANDROID®, WINDOWS®, or other operating systems. In some implementations, the controller 606 may be implemented as part of the processor 602.

In some implementations, the NE 600 may include at least one transceiver 608. In some other implementations, the NE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas to receive a signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

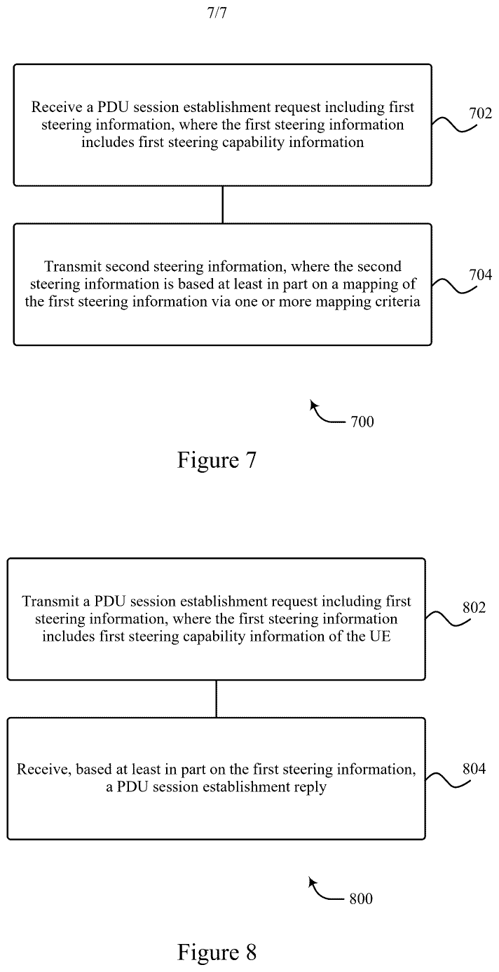

FIG. 7 illustrates a flowchart of a method 700 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 702, the method may include receiving a PDU session establishment request including first steering information, where the first steering information includes first steering capability information. The operations of 702 may be performed in accordance with examples as described herein. In some implementations, aspects of the operations of 702 may be performed by an NE as described with reference to FIG. 6.

At 704, the method may include transmitting second steering information, where the second steering information is based at least in part on a mapping of the first steering information via one or more mapping criteria. The operations of 704 may be performed in accordance with examples as described herein. In some implementations, aspects of the operations of 704 may be performed by an NE as described with reference to FIG. 6.

FIG. 8 illustrates a flowchart of a method 800 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 802, the method may include transmitting a PDU session establishment request including first steering information, where the first steering information includes first steering capability information of the UE. The operations of 802 may be performed in accordance with examples as described herein. In some implementations, aspects of the operations of 802 may be performed by a UE as described with reference to FIG. 4.

At 804, the method may include receiving, based at least in part on the first steering information, a PDU session establishment reply. The operations of 804 may be performed in accordance with examples as described herein. In some implementations, aspects of the operations of 804 may be performed by a UE as described with reference to FIG. 4.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first network equipment (NE) for wireless communication, comprising:
at least one memory; and
at least one processor coupled with the at least one memory and operable to cause the first NE to:
receive a protocol data unit (PDU) session establishment request including first steering information, wherein the first steering information includes first steering capability information; and
transmit second steering information, wherein the second steering information is based at least in part on a mapping of the first steering information via one or more mapping criteria.

2. The first NE of claim 1, wherein the PDU session establishment request comprises a multiple access (MA) PDU session establishment request.

3. The first NE of claim 1, wherein the PDU session establishment request is received from a user equipment (UE).

4. The first NE of claim 3, wherein the PDU session establishment request is associated with device tethering to the UE.

5. The first NE of claim 3, wherein the first steering capability information comprises one or more steering functionalities or one or more steering modes supported by the UE.

6. The first NE of claim 5, wherein when a value associated with the first steering capability information cannot be interpreted by the first NE, the at least one processor is operable to cause the first NE to:
reject the PDU establishment request; and
transmit an error cause based at least in part on rejection of the PDU establishment request.

7. The first NE of claim 1, wherein the second steering information is transmitted to a second NE, and wherein the at least one processor is operable to cause the first NE to:
receive, from the second NE, one or more rules for PDU session establishment; and
transmit at least a portion of the one or more rules.

8. The first NE of claim 7, wherein the first NE comprises a session management function (SMF), and the second NE comprises a policy control function (PCF).

9. The first NE of claim 7, wherein the one or more rules comprise access traffic steering, switching, splitting (ATSSS) rules.

10. The first NE of claim 1, wherein the first steering information comprises a first set of steering information and a second set of steering information, and wherein the second steering information is based at least in part on the first set of steering information and the second set of steering information.

11. The first NE of claim 1, wherein the at least one processor is operable to cause the NE to:
transmit an indication to provide a session management (SM) context identifier for a PDU session.

12. The first NE of claim 1, wherein one or more of the first steering information or the second steering information is associated with one or more of a multipath quick user datagram protocol (UDP) internet protocol (IP) (MPQUIC-IP) steering functionality or an MPQUIC-IP steering mode.

13. A user equipment (UE) for wireless communication, comprising:
at least one memory; and
at least one processor coupled with the at least one memory and operable to cause the UE to:
transmit a first message comprising a protocol data unit (PDU) session establishment request including first steering information, wherein the first steering information includes first steering capability information of the UE; and
receive, based at least in part on the first steering information, a PDU session establishment reply.

14. The UE of claim 13, wherein the PDU session establishment request comprises a multiple access (MA) PDU session establishment request.

15. The UE of claim 13, wherein the PDU session establishment request is associated with device tethering to the UE.

16. The UE of claim 13, wherein the first steering capability information comprises one or more steering functionalities or one or more steering modes supported by the UE.

17. The UE of claim 13, wherein the PDU session establishment request is transmitted via an information element.

18. The UE of claim 13, wherein the first steering information is associated with one or more of a multipath quick user datagram protocol (UDP) internet protocol (IP) (MPQUIC-IP) steering functionality or an MPQUIC-IP steering mode.

19. A method performed by a first network equipment (NE), the method comprising:
receiving a protocol data unit (PDU) session establishment request including first steering information, wherein the first steering information includes first steering capability information; and
transmitting second steering information, wherein the second steering information is based at least in part on a mapping of the first steering information via one or more mapping criteria.

20. A method performed by a user equipment (UE), the method comprising:
transmitting a first message comprising a protocol data unit (PDU) session establishment request including first steering information, wherein the first steering information includes first steering capability information of the UE; and
receiving, based at least in part on the first steering information, a PDU session establishment reply.
